(19) United States
(12) Patent Application Publication
(10) Pub. No.: US 2018/0082326 A1
(43) Pub. Date: Mar. 22, 2018

(54) Testing an Effect of User Interaction with Digital Content in a Digital Medium Environment

(71) Applicant: Adobe Systems Incorporated, San Jose, CA (US)

(72) Inventors: Nikolaos Vlassis, San Jose, CA (US); Mohammad Ghavamzadeh, San Jose, CA (US); Alan John Malek, Los Gatos, CA (US)

(73) Assignee: Adobe Systems Incorporated, San Jose, CA (US)

(21) Appl. No.: 15/269,003

(22) Filed: Sep. 19, 2016

(51) Int. Cl. G06Q 30/02

(52) U.S. Cl. CPC G06Q 30/0242

(57) ABSTRACT

Paired testing techniques in a digital medium environment are described. A testing system receives data that describes user interactions, e.g., with digital content or other items. The data is organized by the testing system as pairs of user exposures to the different item. Filtering is then performed based on these pairs by the testing system to remove “tied” pairs. Tied pair are pairs of user interactions that result in the same output for binary data (e.g., converted or did not convert) or are within a defined threshold amount for continuous non-binary data. The filtered pair data is then tested, e.g., until criteria of a stopping rule are met as part of sequential hypothesis testing. The testing, for instance, may be used to evaluate which item of digital marketing content exhibits a greater effect, if any, on conversion and control subsequent deployment of this digital marketing content as a result.

### BACKGROUND

In digital medium environments, service provider systems strive to provide digital content that is of interest to users. An example of this is digital content used in a marketing context in order to increase a likelihood of conversion of the digital content. Examples of conversion include interaction of a user with the digital content (e.g., a “click-through”), purchase of a product or service that pertains to the digital content, and so forth. A user, for instance, may navigate through webpages of a website of a service provider system. During this navigation, the user is exposed to an advertisement relating to the product or service. If the advertisement is of interest to the user, the user may select the advertisement through interaction with a computing device to navigate to webpages that contain more information about the product or service that is a subject of the advertisement, functionality usable to purchase the product or service, and so forth. Each of these selections thus involves conversion of interaction of the user via the computing device with respective digital content into other interactions with other digital content and/or even purchase of the product or service. Thus, configuration of the advertisements in a manner that is likely to be of interest to the users increases the likelihood of conversion of the users regarding the product or service.

In another example of digital content and conversion, users may agree to receive emails or other electronic messages relating to products or services provided by the service provider. The user, for instance, may opt-in to receive emails of marketing campaigns corresponding to a particular brand of product or service. Likewise, success in conversion of the users towards the product or service that is a subject of the emails directly depends on interaction of the users with the emails. Since this interaction is closely tied to a level of interest the user has with the emails, configuration of the emails also increases the likelihood of conversion of the users regarding the product or service.

Testing techniques have been developed in order for a computing device to determine a likelihood of which items of digital content are of interest to users. An example of this is A/B testing in which different items of digital content are provided to different sets of users. An effect of the different items of the digital content on conversion by the different sets is then compared by a computing device to determine which of the items has a greater likelihood of being of interest to users, e.g., resulting in conversion.

A/B testing involves comparison of two or more options, e.g., a baseline digital content option “A” and an alternative digital content option “B.” In a marketing scenario, the two options include different digital marketing content such as advertisements having different offers, e.g., digital content option “A” may specify 20% off this weekend and digital content option “B” may specify buy one/get one free today.

Digital content options “A” and “B” are then provided to different sets of users, e.g., using advertisements on a webpage, emails, and so on. Testing may then be performed by a computing device through use of a hypothesis. Hypothesis testing involves testing validity of a claim (i.e., a null hypothesis) by a computing device that is made about a population in order to reject or prove the claim. For example, a null hypothesis “H₀” may be defined in which a conversion rate of the baseline is equal to a conversion rate of the alternative, i.e., “H₀: A=B”. An alternative hypothesis “H₁” is also defined in which the conversion rate of the baseline is not equal to the conversion rate of the alternative, i.e., “H₁: A≠B.”

Based on the response from these users, a determination is made by the computing device to reject or not reject the null hypothesis. Rejection of the null hypothesis by the computing device indicates that a difference has been observed between the options, i.e., the null hypothesis that both options are equal is wrong. This rejection takes into account accuracy guarantees that Type I and/or Type II errors are minimized within a defined level of confidence, e.g., to ninety-five percent confidence that these errors do not occur. A Type I error “α” is the probability of rejecting the null hypothesis when it is in fact correct, i.e., a “false positive.” A Type II error “β” is the probability of not rejecting the null hypothesis when it is in fact incorrect, i.e., a “false negative.” From this, a determination is made as to which of the digital content options are the “winner” based on a desired metric, e.g., a conversion rate.

Conventional techniques of A/B testing used by computing devices, however, rely on an assumption of a parametric model to describe data that defines observed user interactions, e.g., with digital content such as advertisements. Computing devices, for instance, conventionally fit a parametric model for A/B testing, such as a Gaussian model, Bernoulli model, and so on to define “what is observed” by the data. The fitting of these models is then used as part of conventional techniques to make a determination of “which is better, A or B,” e.g., to accept or reject the null hypothesis as described above based on distributions within these models.

However, conventional techniques used to assume a parametric model for observed data are often prone to error in real world examples. For example, real world data describing user interaction with digital content and subsequent conversion typically does not “neatly follow” these parametric distributions. As a consequence, any assumption that the parametric form that is followed for these observations in order to perform A/B testing is commonly prone to error in real world environments. This is due to divergence of the real world data from the assumed parametric model. Accordingly, there is a need to support A/B testing in which this data an assumption of a parametric model to the observations is not required, which may increase efficiency and accuracy in performance of A/B testing.

Additionally, a common form of A/B testing is referred to as fixed-horizon hypothesis testing. In fixed-horizon hypothesis testing, inputs are provided manually by a user, and the test is then “run” over a defined number of samples (i.e., the “horizon”) until it is completed. These inputs include a confidence level that refers to the probability of correctly accepting the null hypothesis, e.g., “1—Type I error” which is equal to “1−α”. The inputs also include a power (i.e., statistical power) that defines a sensitivity in a hypothesis test that the test correctly rejects the null hypothesis, e.g., a false negative which may be defined “1—Type II error” which is equal to “1−β”. The inputs further include a baseline conversion rate (e.g., “μ_{A}”) which is the metric being tested in this example. A minimum detectable effect (MDE) is also entered as an input that defines a “lift” that can be detected with the specified power and defines a desirable degree of insensitivity as part of calculation of the confidence level. Lift is formally defined based on the baseline conversion rate as “|μ_{B}−μ_{A}|/μ_{A}.”

From these inputs, a horizon “N” is calculated that specifies a sample size per option (e.g., a number of visitors per digital content options “A” or “B”) required to detect the specified lift of the MDE with the specified power. Based on this horizon “N”, the number “N” samples are collected (e.g., visitors per offer) and the null hypothesis H₀ is rejected if “Λ_{N}≧γ,” where “Λ_{N}” is the statistic being tested at time “N” and “γ” is a decision boundary that is used to define the “winner” subject to the confidence level.

Fixed-horizon hypothesis testing has a number of drawbacks. In a first example drawback, a user that configures the test is forced to commit to a set amount of the minimum detectable effect before the test is run. Further, this commitment may not be changed as the test is run. However, if such a minimal detectable effect is overestimated, this test procedure is inaccurate in the sense that it possesses a significant risk of missing smaller improvements. If underestimated, this testing is data-inefficient because a greater amount of time may be consumed to process additional samples in order to determine significance of the results.

In a second example drawback, fixed-horizon hypothesis testing is required to run until the horizon “N” is met, e.g., a set number of samples is collected and tested. To do otherwise introduces errors, such as to violate a guarantee against Type I errors. For example, as the test is run, the results may fluctuate above and below a decision boundary that is used to reject a null hypothesis. Accordingly, a user that stops the test in response to these fluctuations before reaching the horizon “N” may violate a Type I error guarantee, e.g., a guarantee that at least a set amount of the calculated statistics do not include false positives. Accordingly, there is also a need for testing techniques that may be performed with increased efficiency and accuracy that may support real time feedback which is not possible using conventional fixed horizon testing techniques.

### SUMMARY

Paired testing techniques in a digital medium environment are described. The testing techniques are used to compare different items (e.g., digital content) against each other to determine which of the different items operate “best” as defined by a statistic in achieving a desired action. To do so, a testing system receives data that describes user interactions, e.g., with digital content or other items. The data is organized by the testing system as pairs of user exposures to the different item, e.g., a first user who was exposed to item “A” and a second user who was exposed to item “B.”

Filtering is then performed based on these pairs by the testing system to remove “tied” pairs. Tied pair are pairs of user interactions that result in the same output for binary data (e.g., converted or did not convert) or are within a defined threshold amount for continuous non-binary data, e.g., conversion rate, dollar amounts, and so on. Consequently, “untied” pairs of user exposures to the different options remain. The filtered pair data is then tested, e.g., until criteria of a stopping rule are met as part of sequential hypothesis testing. Sequential hypothesis testing techniques involve testing sequences of increasingly larger number of samples until a “winner” (e.g., item “A” or “B”) is determined based on a stopping rule. One example of a stopping rule involves statistical significance, which defines a confidence level in the accuracy of the results such as against defined amounts of Type I (i.e., false positive) and/or Type II (i.e., false negative) errors.

The testing, for instance, may be used to evaluate which item of digital marketing content exhibits a greater effect, if any, on conversion. This may then be used to control subsequent output of these items of digital marketing content, such as to deploy the item that has exhibited a larger effect on conversion.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ sequential hypothesis testing techniques described herein.

FIG. 2 depicts a system in an example implementation in which a testing system of FIG. 1 is configured to perform sequential hypothesis testing.

FIG. 3 depicts an example of a testing system of FIG. 2 as implementing paired-based testing technique to perform a test as part of sequential hypothesis testing.

FIG. 4 is a flow diagram depicting a procedure in an example implementation in which a paired testing technique is performed to test data describing user interaction with first and second items of digital content to determine an effect of these items on achievement of an action.

FIG. 5 illustrates an example system including various components of an example device that can be implemented as any type of computing device as described and/or utilize with reference to FIGS. 1-4 to implement embodiments of the techniques described herein.

### DETAILED DESCRIPTION

Overview

Testing is used to compare different items (e.g., digital content) against each other to determine which of the different items operate “best” as defined by a statistic in achieving a desired action. In a digital marketing scenario, this statistic includes a determination as to which item of digital content exhibits a greatest effect on conversion. Examples of conversion include interaction of a user with the content (e.g., a “click-through”), purchase of a product or service that pertains to the digital content, and so forth.

Convention A/B testing techniques assume a parametric model to describe observations in data (e.g., user interactions with digital content), such as a Gaussian model, Bernoulli model, and so forth. In other words, a parametric model is typically “fit” to a distribution of data that describes the observations (i.e., the interactions), which is then used for subsequent testing of the data. This model, for instance, is then used as a basis to determine a result of the testing using statistical techniques (e.g., distributions of the observations described using the models), and as such the model provides an underlying basis in the accuracy of the testing. However, in real life scenarios the data that is being tested typically does not “neatly fit” into a parametric model, and thus testing performed using such a model may be prone to error due to departure of the real life data from the parametric model this is to be used for testing.

Accordingly, paired testing techniques are described in the following that are performable perform testing without first assuming a parametric model to fit to observations described by the data. Rather than rely on accuracy in the fitting of a parametric model, the techniques described herein may perform testing by simply determining “which item performs better” in achieving a desired action (e.g., conversion) without making an assumption as to which parametric model likely corresponds to the data describing these interactions, i.e., the samples being tested.

To do so, a testing system receives data that describes user interactions, e.g., with digital content or other items. This may include user interactions with a first item “A” that is to be tested against a second item “B,” such as different advertisements and whether a subsequent action was performed, e.g., conversion of a product or service.

The data is organized by the testing system as pairs of user exposures to the different options, e.g., a first user who was exposed to “A” and a second user who was exposed to “B.” This may be performed in real time as the data is received, and thus may leverage sequential testing techniques as further described below.

Filtering is then performed based on these pairs by the testing system to remove “tied” pairs, i.e., pairs of user interactions that result in the same output. In a binary example, pairs in which users in a pairing are exposed to items “A” and “B,” respectively, and that resulted in performance of an action (e.g., conversion) by both users (1,1) are removed. Likewise, pairs in which users in a pairing are exposed to items “A” and “B,” respectively, and that did not result in performance of the action (e.g., conversion) by both users (0,0) are also removed. Examples in which continuous data is used are also contemplated, in which tied pairs are considered those pairs having first and second values that are within a threshold amount, i.e., conversion rates that do not differ by more than that amount.

Consequently, “untied” pairs of user exposures to the different options remain, e.g., (1,0) and (0,1), as part of this filtering to form a set of filtered pair data. The filtered pair data is then tested until criteria of a stopping rule are met. One example of a stopping rule involves a determination by the testing system as to whether statistical significance has been achieved as to whether to reject the null hypothesis, such that item “B” is considered to perform equally well as item “A.” As previously described, statistical significance defines a confidence level in the accuracy of the results, e.g., based on a level of confidence of a computed result (e.g., conversion) against defined amounts of Type I (i.e., false positive) and Type II (i.e., false negative) errors. Accordingly, statistical significance may be defined as a desired amount of accuracy against these types of errors (e.g., manually or using a predefined threshold) in order to declare a result of the test. This may be performed for binary responses (e.g., whether “clicked” or not) as well as non-binary responses, such as continuous responses including revenue. In this way, testing of items “A” versus “B” may be performed without assumption of a parametric model. Further discussion of these and other examples are included in the following sections.

Additionally, these techniques may be incorporated as part of sequential hypothesis testing and thus may support greater efficiency in a determination of testing results, support real time “look in” as the testing is being performed, and so forth. As previously described, conventional testing is performed using a fixed-horizon hypothesis testing technique in which input parameters are first set to define a horizon. The horizon defines a number of samples (e.g., users visiting a website that are exposed to the items of digital content) to be collected. The size of horizon is used to ensure that a sufficient number of samples are used to determine a “winner” within a confidence level of an error guarantee, e.g., to protect against false positives and false negatives. Examples of types of errors for which this guarantee may be applied include a Type I error (e.g., false positives) and a Type II error (e.g., false negatives) as previously described. As previously described, however, conventional fixed-horizon hypothesis testing techniques have a number of drawbacks including manual specification of a variety of input as a “best guess” that might not be well understood by a user and a requirement that the test is run until a horizon has been reached in order to attain accurate results, e.g., a set number of samples.

In contrast to conventional techniques that are based on a fixed horizon of samples, the disclosed sequential hypothesis testing techniques involve testing sequences of increasingly larger number of samples until a winner is determined. In particular, the winner is determined based on whether a result of a statistic (e.g., a function of the observed samples) has reached statistical significance that defines a confidence level in the accuracy of the results. Thus, statistical significance defines when it is safe to conclude the test, e.g., based on a level of confidence of a computed result (e.g., conversion) against defined amounts of Type I and/or Type II errors. This permits the sequential hypothesis testing technique to conclude as soon as statistical significance is reached and a “winner” declared, without forcing a user to wait until the horizon “N” of a number of samples is reached.

This also permits the user to “peek” into the test to monitor the test in real time as it is being run, without affecting the accuracy of the test. Such a “peek” capability is not possible using fixed-horizon hypothesis testing. Flexible execution is also made possible in that the test may continue to run even if initial accuracy guarantees have been met, such as to obtain higher levels of accuracy, and even permits users to change parameters used to perform the test in real time as the test is performed, e.g., the accuracy levels. This is not possible using conventional fixed-horizon hypothesis testing techniques in which the accuracy levels are not changeable during the test because completion of the test to the horizon number of samples is required.

In the following discussion, digital content refers to content that is shareable and storable digitally and thus may include a variety of types of content, such as documents, images, webpages, media, audio files, video files, and so on. Digital marketing content refers to digital content provided to users related to marketing activities performed, such as to increase awareness of and conversion of products or services made available by a service provider, e.g., via a website. Accordingly, digital marketing content may take a variety of forms, such as emails, advertisements included in webpages, webpages themselves, and so forth.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

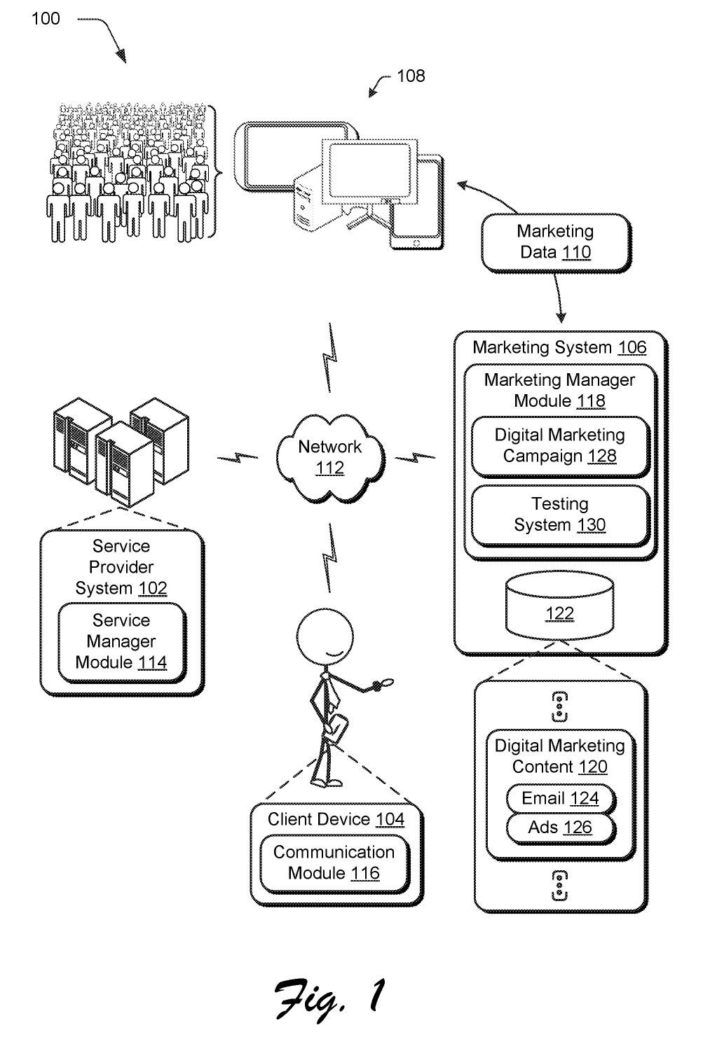

FIG. 1 is an illustration of an environment 100 in an example implementation that is operable to employ testing techniques described herein. The illustrated environment 100 includes a service provider system 102, client device 104, marketing system 106, and source 108 of marketing data 110 (e.g., user interaction with digital content via respective computing devices) that are communicatively coupled, one to another, via a network 112. Although digital marketing content is described in the following, testing may be performed for a variety of other types to digital content, e.g., songs, articles, videos, and so forth, to determine “which is better” in relation to a variety of desired actions. These techniques are also applicable to testing of non-digital content, interaction with which being described using data that is then tested by the systems described herein.

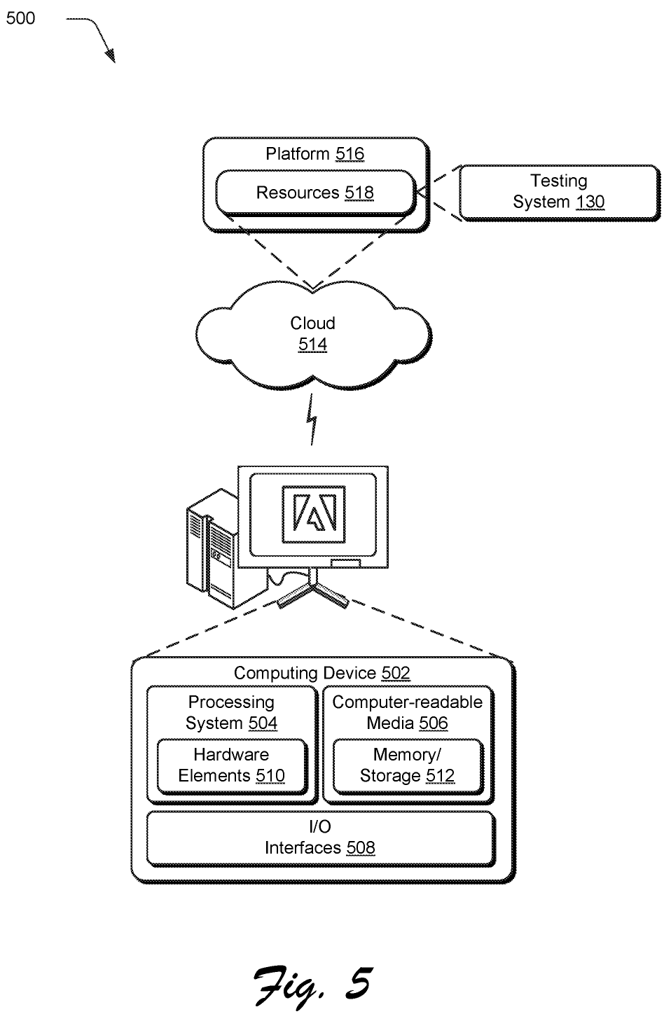

Computing devices that are usable to implement the service provider system 102, client device 104, marketing system 106, and source 108 may be configured in a variety of ways. A computing device, for instance, may be configured as a desktop computer, a laptop computer, a mobile device (e.g., assuming a handheld configuration such as a tablet or mobile phone as illustrated), and so forth. Thus, the computing device may range from full resource devices with substantial memory and processor resources (e.g., personal computers, game consoles) to a low-resource device with limited memory and/or processing resources (e.g., mobile devices). Additionally, a computing device may be representative of a plurality of different devices, such as multiple servers utilized by a business to perform operations “over the cloud” as further described in relation to FIG. 5.

The service provider system 102 is illustrated as including a service manager module 114 that is representative of functionality to provide services accessible via a network 112 that are usable to make products or services available to consumers. The service manager module 114, for instance, may expose a website or other functionality that is accessible via the network 112 by a communication module 116 of the client device 104. The communication module 116, for instance, may be configured as a browser, network-enabled application, and so on that obtains data from the service provider system 102 via the network 112. This data is employed by the communication module 116 to enable a user of the client device 104 to communicate with the service provider system 102 to obtain information about the products or services as well as purchase the products or services.

In order to promote the products or services, the service provider system 102 may employ a marketing system 106. Although functionality of the marketing system 106 is illustrated as separate from the service provider system 102, this functionality may also be incorporated as part of the service provider system 102, further divided among other entities, and so forth. The marketing system 106 includes a marketing manager module 118 that is implemented at least partially in hardware of a computing device to provide digital marketing content 120 for consumption by users, which is illustrated as stored in storage 122, in an attempt to convert products or services of the service provider system 102.

The digital marketing content 120 may assume a variety of forms, such as email 124, advertisements 126, and so forth. The digital marketing content 120, for instance, may be provided as part of a digital marketing campaign 128 to the sources 108 of the marketing data 110. The marketing data 110 may then be generated based on the provision of the digital marketing content 120 to describe which users received which items of digital marketing content 120 (e.g., from particular marketing campaigns) as well as characteristics of the users. From this marketing data 110, the marketing manager module 118 may control which items of digital marketing content 120 are provided to a subsequent user, e.g., a user of client device 104, in order to increase a likelihood that the digital marketing content 120 is of interest to the subsequent user.

Part of the functionality usable to control provision of the digital marketing content 120 is represented as a testing system 130. The testing system 130 is representative of functionality implemented at least partially in hardware (e.g., a computing device) to test an effect of the digital marketing content 120 on achieving a desired action, e.g., a metric such as conversion of products or services of the service provider system 102. The testing system 130, for instance, may estimate a resulting impact of items of digital marketing content 120 on conversion of products or services of the service provider system 102, e.g., as part of A/B testing. A variety of techniques may be used by the testing system 130 in order to perform this estimation, an example of which is described in the following and shown in a corresponding figure. Although data (e.g., the marketing data 110) that describes user interaction with digital content is discussed in the following as an example, the data being tested may also be used to describe user interaction with non-digital content, such as physical products or services, which is then tested using the systems described herein.

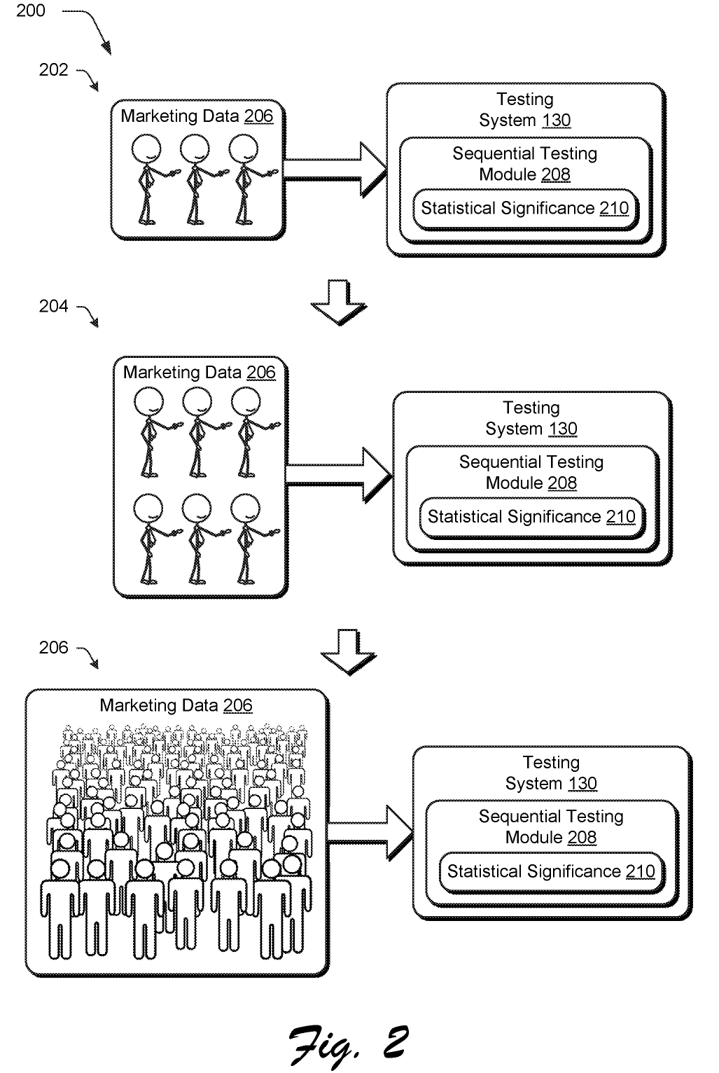

FIG. 2 depicts a system 200 in an example implementation in which the testing system 130 of FIG. 1 is configured to perform sequential hypothesis testing. The system 200 is illustrated using first, second, and third stages 202, 204, 206. The testing system 130 in this example includes a sequential testing module 208. The sequential testing module 208 is implemented at least partially in hardware to perform sequential hypothesis testing to determine an effect of different options on a metric, e.g., conversion rate. Continuing with the previous example, the sequential testing module 208 may collect marketing data 206 which describes interaction of a plurality of users via respective computing devices with digital marketing content 120. From this, an effect is determined of different items of digital marketing content 120 (e.g., items “A” and “B”) on achievement of a desired action, e.g., conversion of a product or service being offered by the service provider system 102. Although two options are described in this example, sequential hypothesis testing may be performed for more than two options.

To perform sequential hypothesis testing, the sequential testing module 208 evaluates the marketing data 206 as it is received, e.g., in real time, to determine an effect of digital marketing content 120 on conversion. A stopping rule is then employed to determine when the testing may stop, an example of which is statistical significance 210. Statistical significance 210 is used to define a point at which is it considered “safe” to consider the test completed, i.e., declare a result. That is, a “safe” point of completion is safe with respect to an amount of false positives or false negatives permitted. This is performed in sequential hypothesis testing without setting the horizon “N” beforehand, which is required under the conventional fixed-horizon hypothesis testing. Thus, a result may be achieved faster and without requiring a user to provide inputs to determine this horizon.

The “sequence” referred to in sequential testing refers to a sequence of samples (e.g., the marketing data 206) that are collected and evaluated to determine whether statistical significance 210 has been reached. At the first stage 202, for instance, the sequential testing module 208 may collect marketing data 206 describing interaction of users with items “A” and “B” of the digital marketing content 120. The sequential testing module 208 then evaluates this marketing data 206 to compare groups of the users that have received item “A” with a group of the users that have received item “B,” e.g., to determine a conversion rate exhibited by the different items. Statistical significance 210 is also computed to determine whether it is “safe to stop the test” at this point, e.g., in order to reject the null hypothesis.

For example, a null hypothesis “H₀” is defined in which a conversion rate of the baseline is equal to a conversion rate of the alternative, i.e., “H₀: A=B”. An alternative hypothesis “H₁” is also defined in which the conversion rate of the baseline is not equal to the conversion rate of the alternative, i.e., “H₁: A≠B.” Based on the response from these users described in the marketing data 206, a determination is made whether to reject or not reject the null hypothesis. Whether it is safe to make this determination is based on statistical significance 210, which takes into account accuracy guarantees regarding Type I and Type II errors, e.g., to ninety-five percent confidence that these errors do not occur.

A Type I error “a” is the probability of rejecting the null hypothesis when it is in fact correct, i.e., a false positive. A Type II error “β” is the probability of not rejecting the null hypothesis when it is in fact incorrect, i.e., a false negative. If the null hypothesis is rejected (i.e., a conversion rate of the baseline is equal to a conversion rate of the alternative) and is statistically significant (e.g., safe to stop), the sequential testing module 208 may cease operation as further described in greater detail below. Other examples are also contemplated in which operation continues as desired by a user, e.g., to achieve results with increased accuracy and thus promote flexible operation.

If the null hypothesis is not rejected (i.e., a conversion rate of the baseline is equal to a conversion rate of the alternative and/or it is not safe to stop), the sequential testing module 208 then collects additional marketing data 206 that describes interaction of additional users with items “A” and “B” of the digital marketing content 120. For example, the marketing data 206 collected at the second stage 204 may include marketing data 206 previously collected at the first stage 202 and thus expand a sample size, e.g., a number of users described in the data. This additional data may then be evaluated along with the previously collected data by the sequential testing module 208 to determine if statistical significance 210 has been reached. If so, an indication may be output that it is “safe to stop” the test in a user interface. Testing may also continue as previously described or cease automatically.

If not, the testing continues as shown for the third stage 206 in which an even greater sample size is collected for addition to the previous samples. In this way, once statistically significant results have been obtained, the process may stop without waiting to reach of predefined horizon “N” as required in conventional fixed-horizon hypothesis testing. This acts to conserve computational resources and results in greater efficiency, e.g., an outcome is determined in a lesser amount of time. Greater efficiency, for instance, may refer to an ability to fully deploy the winning option (e.g., the item of digital marketing content exhibiting the greatest conversion rate) at an earlier point in time. This increases a rate of conversion and reduces opportunity cost incurred as part of testing. For example, a losing option “a” may be replaced by the winning option “B” faster and thus promote an increase in the conversion rate sooner than by waiting to reach the horizon. In one example, increases in the sample size from the first, second, and third stages 202, 204, 206 is achieved through receipt of streaming data that describes these interactions.

Mathematically, the sequential testing module 208 accepts as inputs a confidence level (e.g., “1—Type I” error which is equal to “1−α”) and a power (e.g., “1—Type II error” which is equal to “1−β”). The sequential testing module 208 then outputs results of a statistic “Λₙ” (e.g., a conversion rate) and a decision boundary “γₙ” at each time “n.” The sequential testing module 208 may thus continue to collect samples (e.g., of the marketing data 206), and rejects the null hypothesis H₀ as soon as “Λₙ≧γₙ,” i.e., the results of the statistic are statistically significant 210. Thus, in this example the testing may stop once statistical significance 210 is reached. Other examples are also contemplated, in which the testing may continue as desired by a user, e.g., to increase an amount of an accuracy guarantee as described above.

Results of the sequential testing may be provided to a user in a variety of ways to monitor the test during and after performance of the test, which is not possible in conventional fixed horizon testing techniques. Further description of sequential hypothesis testing may be found at U.S. patent application Ser. No. 15/148,920, filed May 6, 2016, and titled “Sequential Hypothesis Testing in a Digital Medium Environment,” the entire disclosure of which is hereby incorporated by reference.

Sequential Testing Using a Dueling Based Technique

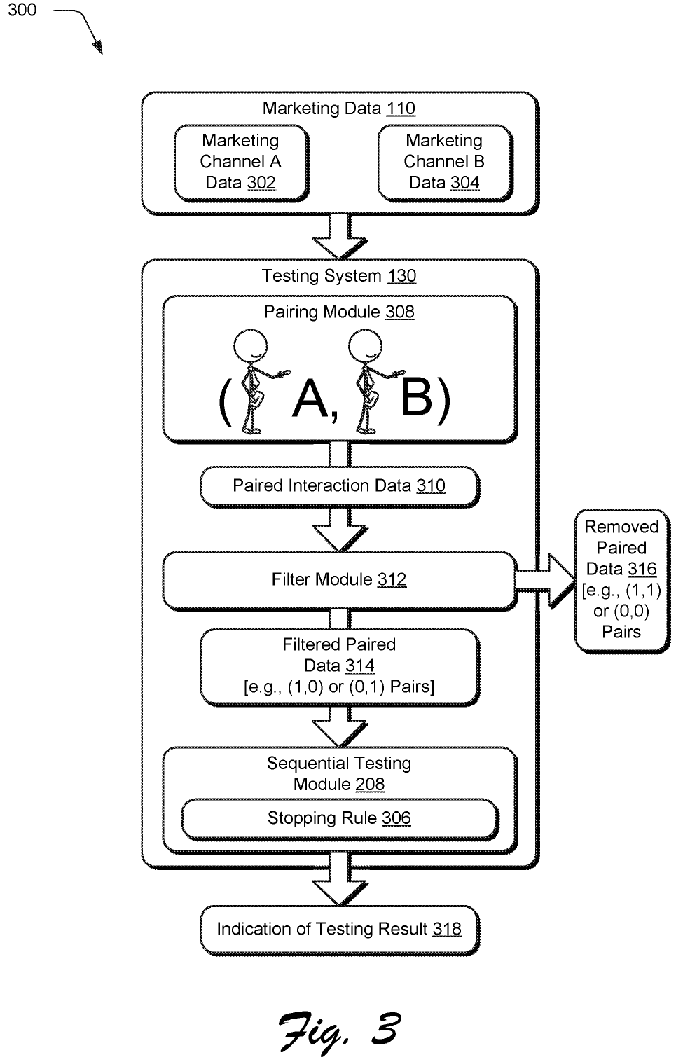

FIG. 3 depicts an example 300 of the testing system 130 of FIG. 2 as implementing paired-based testing technique to perform a test as part of sequential hypothesis testing. In this example, A/B testing techniques are usable to avoid the fitting of observations of the marketing data 110 (e.g., samples of user interactions) to particular parametric assumptions of “A” or “B”, but rather may be performed independently of such assumptions. Parametric forms may then be used later to compare results from testing of this data (e.g., using probability theory such as a Martingale), but not to fit observations to parametric forms before testing which may be prone to error as previously described.

For example, the marketing system 106 of FIG. 1 may provide two items of digital marketing content 120 as different options to achieve a desired action, e.g., conversion. Items “A” and “B”, for instance, may be configured as two offers having different candidate digital images of a hotel. These two offers are considered as different marketing channels towards obtaining the same desired action, e.g., conversion. A user of the marketing system 106 may then wish to determine, through interaction with the marketing manager module 118, which item performs “better” in achieving the action, i.e., results in a greater number of conversions.

The marketing system 106 does so by first randomly assigning incoming traffic to users of the computing devices to items “A” or “B,” which acts as a source 108 of the marketing data 110 as described in relation to FIG. 1. The marketing data 110 may thus be classified according to marketing channel based on the items, with which, user interaction occurred, examples of which are illustrated as marketing channel A data 302 and marketing channel B data 304.

This marketing data 110 is then tested by the testing system 130, which supports not only a determination of a result as to which item has “better” performance, but also when the testing may conclude according to a stopping rule. One example of a stopping rule involves when it is considered “safe” to declare that result as described in FIG. 2, e.g., has reached statistical significance as part of sequential hypothesis testing. This is in contrast to conventional fixed-horizon hypothesis tests that require an entirety of a test to be performed before formation of a result. As such, conventional fixed-horizon hypothesis tests do not support real time feedback before reaching this result as such feedback may have an adverse effect on the accuracy of the result as described in the Background section above.

Continuing with the previous hotel example above, conventional techniques pre-calculate an amount of traffic (e.g., number of samples) to be assigned to “A” or “B” before a result may be achieved. This may be inefficient in situations in which an assumption may be safely made (e.g., in relation to statistical significance) before this amount is reached. Accordingly, through use of a stopping rule 306 such as statistical significance 210 of FIG. 2 as part of a sequential hypothesis testing, testing may be completed before reaching the fixed number of samples required in conventional fixed horizon techniques. This helps to improve efficiency both in testing as well as deployment of the item that performs better in achieving the desired action, e.g., the advertisement that increases conversion of a product or service.

In the illustrated example, marketing data 110 is received by the testing system 130. The marketing data 110 describes user interaction with marketing channel A (e.g., received advertisement “A”) using marketing channel A data 302 and with marketing channel B (e.g., received advertisement “B”) using marketing channel B data 304. This data may be obtained in a variety of ways, such as a collection (e.g., a single file), streamed in real time, and so on.

The testing system 130 then employs a pairing module 308 that is implemented at least partially in hardware of a computing device. The pairing module 308 is configured to form paired interaction data 310 from the marketing data 110. The paired interaction data 310 describes pairs of user interactions with items “A” and “B” via respective marketing channels. The pairing module 308, for instance, may receive streams of the marketing data in real time, and thus user interaction with item “A” may be temporally correlated with another user interaction with item “B”. These interactions may thus form a pair as correlated by time based on when this data is received. Additionally, potential bias may be avoided by forming these pairs in real time and thus improve accuracy in the results that otherwise may be introduced using conventional techniques. Conventional techniques, for instance, that are used to systematically select the pairs may introduce errors based on “how” the pairs are selected. Other correlations other than time may also be used to form the paired interaction data 310.

As illustrated, the pairs include first and second values that describe user interactions with items “A” and “B,” respectively, in achieving a desired action, e.g., conversion. This user interaction may be performed by the same or different users. In a binary conversion example in the following, user interaction with item “A” that resulted in conversion is represented using a value of “1.” User interaction with an item “A” that did not result in conversion is represented using a value of “0”. Likewise, user interaction with item “B” that resulted in conversion is represented using a value of “1” and that did not result in conversion is represented using a “0.” Accordingly, a pair in which both user interactions resulted in conversion is represented as first and second values of (1,1) for respective first and second items, i.e., “A” and “B”. Likewise, a pair in which both user interactions did not result in conversion is represented as first and second values of (0,0) for respective first and second items. Both of these examples are considered to have tied pairs because the first and second values match, one to another.

On the other hand, untied pairs do not have matching values. For example, a pair in which user interaction with the first item “A” resulted in conversion and user interaction with the second item “B” did not result in conversion has first and second values of (1,0) that do not match and thus are untied pairs. Also, a pair in which user interaction with the first item “A” did not result in conversion and user interaction with the second item “B” did result in conversion has first and second values of (0,1) that do not match and thus are untied pairs.

The testing system 130, as previously described, is configured to determine which of these items “A” or “B” exhibits better performance in achieving a desired action, e.g., conversion. This is performed without use of an assumption of a parametric form to the marketing data 110, i.e., fitting a parametric form to observations in samples being tested. To do so, the testing system 130 leverages this pairing of user interactions, i.e., observations regarding the desired action. Continuing with the previous example, the pairing module 408 forms paired interaction data 310 upon receipt of user interactions that are correlated (e.g., same or similar time stamps) with items “A” and “B” to form the pairs within the paired interaction data 310 as described above.

A filter module 312 is then implemented at least partially in hardware of a computing device to form filtered paired data 314. To do so, the filter module 312 is configured to remove paired data 316 from the paired interaction data 310 having ties, i.e., have matching first and second values such as (1,1) or (0,0) in a binary example. In other words, if both values indicate that the user interactions both resulted in conversion or both did not result in conversion, those tied pairs are removed to form filtered paired data 314. In another example, the user interactions are described using continuous and non-binary data, such as conversion rates, monetary amounts, and so forth. In this other example, a threshold amount is used to define an amount of difference in which the values are considered “tied” or “untied” by differences that are greater or less than the threshold amount, respectively. Regardless of the type of data, the filtered paired data 314 includes the untied pairs that remain from the paired interaction data 310, e.g., have first and second values that do not match, one to another, in a binary example or differ by more than the threshold amount in a continuous non-binary example.

The filtered paired data 314 having the untied pairs is then tested by the sequential testing module 208 as previously described in relation to FIG. 2 to test ever increasing larger numbers of samples (i.e., user interactions) until criteria of a stopping rule 306 is met. The sequential testing module 208, for instance, may employ a stopping rule 306 that is based on a statistical significance 210. Statistical significance 210, as previously described, is a confidence level defined based on an amount of a Type I error that defines a probability of a false positive and/or an amount of a Type II error that defines a probability of a false negative. Thus, once statistical significance 210 is reached it may be considered “safe” to stop the test as being protected to a threshold degree (e.g., which may be user defined) against these type of errors. In this way, sequential hypothesis testing may be performed with increased efficiency in comparison with conventional fixed-horizon hypothesis testing techniques as previously described.

Because the output of the testing is binary in this example (e.g., whether “A” is exhibits better performance than “B” in achieving a desired action), the output may then be modeled as a Bernoulli distribution. A Bernoulli distribution is a probability distribution of a random variable that takes the value “1” with success probability of p and a value “0” with a failure probability of “q−1−p”. A Bernoulli distribution, for instance, may be used to represent a coin toss where “1” and “0” represent “heads” and “tails,” respectively. Thus, a Bernoulli distribution may be used by the testing system 130 to represent results of the testing in a manner that is well-characterized and readily understood. Also, it should be noted that this distribution is used to analyze the results of the testing, but is not used to represent observations being tested and thus may protect against the inaccuracies of conventional techniques that fit parametric models to observations (e.g., user interactions) before testing.

The testing results from the sequential testing module may be considered as an actual Martingale using the techniques described herein, as opposed to an approximation of a Martingale as performed in conventional techniques and thus may also exhibit increased accuracy. A Martingale, in probability theory, is a model of a fair game where knowledge of past events does not aid accuracy in prediction of a mean of future winnings. In particular, a Martingale is a sequence of random variables (i.e., a stochastic process) for which, at a particular time in a sequence of samples, the expectation of a next value in the sequence is equal to the present observed value even given knowledge of each prior observed value. In the coin flip example above, for instance, a result of a current coin flip is independent of a previous coin flip. Thus, Martingales exclude the possibility of winning strategies based on game history, and thus are a model of “fair games.” As such, the testing results are considered an actual Martingale and thus exhibit increased accuracy as opposed to an approximation of a Martingale of convention techniques. Conventional approximation of a Martingale, for instance, that may introduce bias based on inaccuracies in forming the approximation and thus may depart from a definition of a “fair game” as described above and introduce bias.

An indication of the testing result 318 may then be output in a user interface, such as whether the null hypothesis is rejected (e.g., and thus item “B” exhibits statistically significant better performance in achieving a desired action than item “A”), an indication of the statistical significance, and so on. Further, by leveraging sequential hypothesis testing techniques this indication may be output in real time in the user interface, which is not possible in fixed-horizon hypothesis testing techniques as previously described due to violation of the statistical guarantee that defines a basis of the test. Further discussion of this and other features is included in the following Implementation Example section.

### Implementation Example

In the following, an implementation example is described mathematically. In this example, like above, a number “n” of user interactions with items “A” and “B” are paired, which may be expressed as first and second values as “{(xᵢ, yᵢ)}ᵢ₌₁ⁿ” and tied pairs are removed, i.e., pairs that are of the form (0, 0) and (1, 1) for binary data or are within a threshold amount for continuous non-binary data. A “winner” is declared for items “A” or “B” based on a proportion of the number of (1, 0) pairs to the total number of untied pairs, i.e.,

$${\hat{θ}}_{n} = \frac{k}{m} ,$$

where k is the number of (1,0) pairs and m is the total number of untied pairs. The quantity \hat{θ}ₙ is the main statistic of the dueling method, which means that the null and alternative hypothesis of A/B testing can be defined as

$$“ {H}_{0} \text{:} θ = \frac{1}{2} ” and “ {H}_{1} \text{:} θ \neq \frac{1}{2} , ”$$

respectively, in which “θε[0, 1]” is the true proportion of (1, 0) pairs to the total number of untied pairs in a binary example. Therefore, the only parameter of each model/hypothesis is “θ,” and thus, the likelihood function of the statistic is a binomial parameterized by k and m as follows:

Lₙ(θ=θ₁)∝θ₁^{k}(1−θ₁)^{m-k}.

As a result, a likelihood ratio for the simple null hypothesis

$$“ {H}_{0} \text{:} θ = \frac{1}{2} ”$$

versus a simple alternative hypothesis “H₁: θ=θ₁” can be written as follows:

$${Λ}_{n} = \frac{Pr ( 𝒟 \vert {H}_{1} )}{Pr ( 𝒟 \vert {H}_{0} )} = \frac{{L}_{n} ( θ = {θ}_{1} )}{{L}_{n} ( θ = 1 / 2 )} = \frac{{{θ}_{1}^{k} ( 1 - {θ}_{1} )}^{m - k}}{{( 1 / 2 )}^{m}} = {2}^{m} {{θ}_{1}^{k} ( 1 - {θ}_{1} )}^{m - k} .$$

where D is the set of data and Ln is the likelihood function. From the above, this statistic is a Martingale under the null hypothesis, i.e., follows a model of a fair game as previously described. In the testing techniques described herein, the alternative hypothesis is a composite,

$$“ {H}_{1} \text{:} θ \neq \frac{1}{2} , ”$$

and thus the average likelihood ratio is computed as follows:

$${Λ}_{n} = \frac{\int Pr ( θ \vert {H}_{1} ) Pr ( 𝒟 \vert θ , {H}_{1} ) d θ}{{L}_{n} ( θ = 1 / 2 )} .$$

Given a Beta prior with parameter [symbol] over θ, i.e., Pr(θ|H₁)=B(θ; [symbol] ), we may compute the average likelihood ratio using the following:

$${Λ}_{n} ( τ ) = \frac{\int {L}_{n} ( θ ) B ( θ ; τ , τ ) d θ}{{L}_{n} ( θ = 1 / 2 )} = {\int }_{0}^{1} {2}^{m} {{θ}^{k} ( 1 - θ )}^{m - k} \frac{1}{β ( τ , τ )} {{θ}^{τ - 1} ( 1 - θ )}^{τ - 1} d θ = \frac{{2}^{m}}{β ( τ , τ )} {\int }_{0}^{1} {{θ}^{k + τ - 1} ( 1 - θ )}^{m - k + τ - 1} d θ = \frac{{2}^{m} β ( k + τ , m - k + τ )}{β ( τ , τ )} ,$$

where “β(·,·)” is the Beta function. The value “Λₙ( [symbol] )” is a Martingale under the null hypothesis, and thus, “P₀ (Λₙ( [symbol] )≦1/b.” Accordingly, a stopping rule may be employed to stop sequential hypothesis testing as soon as “Λₙ( [symbol] )≧1/α,” which supports Type I error control at level “α.” The stopping rule may be defined as follows:

$${Λ}_{n} ( τ ) = \frac{{2}^{m} β ( k + τ , m - k + τ )}{β ( τ , τ )} \geq \frac{1}{α} . \qquad ( i )$$

Since “Λₙ( [symbol] )” is a positive martingale under the null hypothesis, the Type I error guarantee of this technique is exact. Also, since the statistic “Λₙ( [symbol] )” of this technique is a true martingale under the null hypothesis, a value (from the historical and synthetic data) for the free parameter of this method, “ [symbol] ” may be found that supports reasonable performance.

These techniques may also be employed for continuous, i.e., non-binary, data. For example, user interactions with items “A” and “B” are paired as before as “{(xᵢ, yᵢ)}ᵢ₌₁ⁿ,” and then tied pairs are discarded. In this scenario, tied pairs are defined as a pair of first and second values “(xᵢ, yᵢ)” that do not differ by more than a threshold, i.e., such that “|xᵢ−yᵢ|≦ε.” The total number of untied pairs “m” is then counted and the total number of untied pairs in which “xᵢ>yᵢ,k.” The main statistic here is “\hat{θ}ₙ=k/m,” whose likelihood is binomial, and thus, proportional to “θ^{k} (1−θ)^{m-k},” where “θε[0,1]” is the true proportion of the number of untied pairs in which “xᵢ>yᵢ” to the total number of untied pairs. Similar to binary example above, the null and alternative hypotheses may be expressed as

$$“ {H}_{0} \text{:} θ = \frac{1}{2} ” and “ {H}_{1} \text{:} θ \neq \frac{1}{2} , ”$$

respectively. Accordingly, the average likelihood ratio may be expressed as:

$${Λ}_{n} ( τ ) = \frac{\int Pr ( θ \vert {H}_{1} ) Pr ( 𝒟 \vert θ , {H}_{1} ) d θ}{{L}_{n} ( θ = 1 / 2 )} = \frac{\int {L}_{n} ( θ ) B ( θ ; τ , τ ) d θ}{{L}_{n} ( θ = 1 / 2 )} = \frac{{2}^{m} β ( k + τ , m - k + τ )}{β ( τ , τ )} ,$$

where “B(θ; [symbol] )” is a Beta prior over “θ” with parameter “ [symbol] ” and “β(·,·)” is the Beta function. This statistic is also a martingale under the null hypothesis, and thus, the stopping rule may be defined to stop as soon as “Λₙ( [symbol] )≧1/α,” which controls an amount of permitted Type I error. This stopping rule may be written as:

$${Λ}_{n} ( τ ) = \frac{{2}^{m} β ( k + τ , m - k + τ )}{β ( τ , τ )} \geq \frac{1}{α} .$$

Further discussion of these and other examples is included in the following section.

### Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-3.

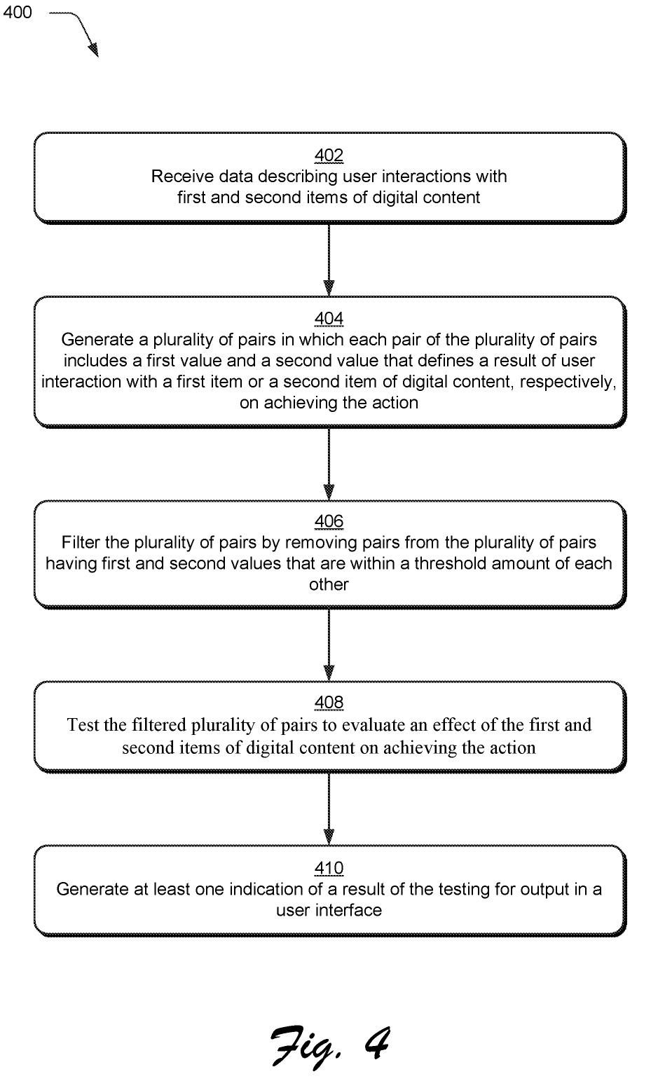

FIG. 4 depicts a procedure 400 in an example implementation in which a paired testing technique is performed to test data describing user interaction with first and second items of digital content to determine an effect of these items on achievement of an action. Data is received that describes user interaction with first and second items of digital content (block 402), such as advertisements, digital images, and so forth. Other user interactions are also contemplated, such as non-digital content including physical products or services.

A plurality of pairs is generated in which each pair of the plurality of pairs includes a first value and a second value that defines a result of user interaction with a first item or a second item of digital content, respectively, on achieving an action (block 404). Thus, each of the plurality of pairs includes first and second values. The first value defines a result of user interaction with a first item of digital content on achieving an action, such as conversion of a product or service. The second value defines a result of user interaction with a second item of digital content on achieving the action, such as conversion of the same product or service. The first and second values may be binary (e.g., whether or not action occurred) or continuous and non-binary, e.g., conversion rates, dollar amounts, and so forth.

The plurality of pairs is filtered by removing pairs from the plurality of pairs having first and second values that are within a threshold amount of each other (block 406). For continuous and non-binary data, for instance, this threshold amount may define an amount of difference between the values that is permitted and still be considered as “tied.” For binary data, this threshold amount may be defined such that the values match, e.g., (0,0) or (1,1).

The filtered plurality of pairs are then tested to evaluate an effect of the first and second items of digital content on achieving the action (block 410). Sequential hypothesis testing techniques, for instance, may be employed by the testing system 130 as described in relation to FIG. 2 in order to determine whether to reject the null hypothesis. Other testing techniques may also be employed.

At least one indication is generated of a result of the testing for output in a user interface (block 410). The indication, for instance, may describe whether to reject the null hypothesis and thus that one item did perform better in achieving the action, e.g., conversion. The indication may also define an amount of statistical confident in a result of the testing, i.e., protection against a Type I and/or Type II errors. The indication may also be output in real time as the testing is performed, which is not possible in conventional fixed horizon hypothesis testing.

### Example System and Device

FIG. 5 illustrates an example system generally at 500 that includes an example computing device 502 that is representative of one or more computing systems and/or devices that may implement the various techniques described herein. This is illustrated through inclusion of the testing system 130. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interface 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware element 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 506 is illustrated as including memory/storage 512. The memory/storage 512 represents memory/storage capacity associated with one or more computer-readable media. The memory/storage component 512 may include volatile media (such as random access memory (RAM)) and/or nonvolatile media (such as read only memory (ROM), Flash memory, optical disks, magnetic disks, and so forth). The memory/storage component 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable storage media and/or hardware elements 510 of the processing system 504. The instructions and/or functions may be executable/operable by one or more articles of manufacture (for example, one or more computing devices 502 and/or processing systems 504) to implement techniques, modules, and examples described herein.

The techniques described herein may be supported by various configurations of the computing device 502 and are not limited to the specific examples of the techniques described herein. This functionality may also be implemented all or in part through use of a distributed system, such as over a “cloud” 514 via a platform 516 as described below.

The cloud 514 includes and/or is representative of a platform 516 for resources 518. The platform 516 abstracts underlying functionality of hardware (e.g., servers) and software resources of the cloud 514. The resources 518 may include applications and/or data that can be utilized while computer processing is executed on servers that are remote from the computing device 502. Resources 518 can also include services provided over the Internet and/or through a subscriber network, such as a cellular or Wi-Fi network.

The platform 516 may abstract resources and functions to connect the computing device 502 with other computing devices. The platform 516 may also serve to abstract scaling of resources to provide a corresponding level of scale to encountered demand for the resources 518 that are implemented via the platform 516. Accordingly, in an interconnected device embodiment, implementation of functionality described herein may be distributed throughout the system 500. For example, the functionality may be implemented in part on the computing device 502 as well as via the platform 516 that abstracts the functionality of the cloud 514.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium testing environment to evaluate an effect of user interactions with digital content on achieving an action, a method implemented by at least one computing device, the method comprising:
generating, by the at least one computing device, a plurality of pairs in which each pair of the plurality of pairs includes a first value and a second value that defines a result of user interaction with a first item or a second item of digital content, respectively, on achieving the action;
filtering, by the at least one computing device, the plurality of pairs by removing pairs from the plurality of pairs having first and second values that are within a threshold amount of each other;
testing, by the at least one computing device, the filtered plurality of pairs to evaluate an effect of the first and second items of digital content on achieving the action; and
generating, by the at least one computing device, at least one indication of a result of the testing for output in a user interface.

2. The method as described in claim 1, wherein the action is conversion of a product or service.

3. The method as described in claim 2, wherein the conversion is defined using a conversion rate or a monetary amount.

4. The method as described in claim 1, wherein the generating of the plurality of pairs, the filtering, the testing, and the generating of the at least one indication are performed in real time as data is received by the at least one computing device that is used to perform the generating of the plurality of pairs.

5. The method as described in claim 1, wherein the testing further comprises sequential hypothesis testing that employs a stopping rule.

6. The method as described in claim 5, wherein the stopping rule is based at least in part on statistical significance of the first and second items of digital content on the achieving of the result based on an amount of Type I error that defines a probability of a false positive.

7. The method as described in claim 1, wherein the filtering includes keeping pairs from the plurality of pairs having first and second values that are not within a threshold amount of each other as part of the filtered pair data.

8. The method as described in claim 1, wherein the first and second values are defined using continuous non-binary data.

9. The method as described in claim 1, wherein the first and second values are defined using binary data and the removed pairs from the plurality of pairs having first and second values that match, one to another.

10. In a digital medium testing environment to evaluate an effect of user interactions with digital marketing content on conversion, a method implemented by at least one computing device, the method comprising:
generating, by the at least one computing device, a plurality of pairs in which each pair of the plurality of pairs includes a first value and a second value that defines a result of user interaction with a first item or a second item of digital marketing content, respectively, on conversion;
filtering, by the at least one computing device, the plurality of pairs by removing pairs from the plurality of pairs having first and second values that are within a threshold amount of each other;
applying sequential hypothesis testing, by the at least one computing device, on the filtered plurality of pairs to evaluate an effect of the first and second items of digital marketing content on conversion; and
controlling, by the at least one computing device, output of the first and second items of digital marketing content based at least in part on the applying of the sequential hypothesis testing.

11. The method as described in claim 10, wherein the first and second values are defined using continuous non-binary data.

12. The method as described in claim 10, wherein the first and second values are defined using binary data and the removed pairs from the plurality of pairs having first and second values that match, one to another.

13. The method as described in claim 10, wherein the filtering includes keeping pairs from the plurality of pairs having first and second values that are not within a threshold amount of each other as part of the filtered pair data.

14. The method as described in claim 10, wherein the applying of the sequential hypothesis testing employs a stopping rule based at least in part on statistical significance of the first and second items of digital content on the achieving of the result based on an amount of Type I error that defines a probability of a false positive.

15. In a digital medium testing environment to evaluate an effect of user interactions with digital content on achieving an action, a system comprising:
a pairing module implemented at least partially in hardware of a computing device to generate a plurality of pairs in which each pair of the plurality of pairs includes a first value and a second value that defines a result of user interaction with a first item or a second item of digital content, respectively, on achieving the action:
a filter module implemented at least partially in hardware of a computing device to filter the plurality of pairs by removing pairs from the plurality of pairs having first and second values that are within a threshold amount of each other;
a sequential testing module implemented at least partially in hardware to:
sequentially hypothesis test the filtered plurality of pair to evaluate an effect of the first and second items of digital content on the achieving the action; and
generate at least one indication of a result of the sequential hypothesis test for output in a user interface.

16. The system as described in claim 15, wherein the action is conversion of a product or service.

17. The system as described in claim 15, wherein the sequential hypothesis testing employs a stopping rule based at least in part on statistical significance of the first and second items of digital content on the achieving of the result based on an amount of Type I error that defines a probability of a false positive.

18. The system as described in claim 15, wherein the first and second values are defined using continuous non-binary data.

19. The system as described in claim 15, wherein the first and second values are defined using binary data and the removed pairs from the plurality of pairs having first and second values that match, one to another.

20. The system as described in claim 15, wherein the filtering by the filter module includes keeping pairs from the plurality of pairs having first and second values that are not within a threshold amount of each other as part of the filtered pair data.
